(19) United States
(12) Patent Application Publication
(10) Pub. No.: US 2001/0033273 A1
(43) Pub. Date: Oct. 25, 2001

(54) Touch panel device driver and the associated method

(75) Inventor: Chien-Fa Wang, Taipei Hsien (TW)

Correspondence Address: DARBY & DARBY P.C., 805 Third Avenue, New York, NY, 10022, US

(73) Assignee: Via Technologies, Inc.

(21) Appl. No.: 09/756,534

(22) Filed: Jan. 8, 2001

(30) Foreign Application Priority Data
Apr. 20, 2000 (TW) 89107429

(51) Int. Cl. G09G 5/00

(52) U.S. Cl. 345/173

(57) ABSTRACT

A touch panel device driver for processing inputs from a touch panel. The touch panel device driver operates in either a normal mode or a compact mode. If the touch panel device driver operates in the normal mode, x and y coordinate data for all touched points from the touch panel are processed. If the touch panel device driver operates in the compact mode, only the x and y coordinate data for the pen-up and pen-down points from the touch panel are processed. Thereby, the system workload is reduced significantly.

### FIELD OF THE INVENTION

The present invention relates to a software driver technique, and more particularly, to a touch panel device driver that provides a simplified structure and a simplified mode for processing motion track coordinate points, so as to improve system performance and speed up system response.

### DESCRIPTION OF THE PRIOR ART

A software driver is necessary for the devices of general computer systems to functionally associate a hardware device with an operation system (or an application program in it). In other words, as far as a computer system structure is concerned, the device driver is above the hardware device, which is the lowest layer, and under the operation system, which is the higher layer. FIG. 1 shows the schematic structure of a device driver in a conventional computer system. As shown in the figure, a device driver 20, located between an operation system 10 including the application programs executed therein and a hardware device 30, is responsible for receiving instructions from the operation system 10 to perform the functions of setting, controlling and data transfer for the hardware device 30.

For a more flexible structure, most device drivers use a dual-layer structure internally. As shown in FIG. 1, the device driver 20 can be further divided into a model device driver layer (referred to as MDD layer hereinafter) 22, which is close to the operation system 10, and a platform-dependent driver layer (referred to as PDD layer hereinafter) 24. The MDD layer 22 is an interface that establishes operation system calls. The PDD layer 24 is the interface that establishes the controls over particular hardware devices. Both the MDD layer 22 and the PDD 24 layer are connected by function calls. Such a design is mainly utilized for the design flexibility of a device driver.

Take the control of a touch panel as an example. FIG. 2 shows a schematic diagram of the drive structure of a touch panel in a conventional computer system. As shown in FIG. 2, a touch panel 32 is controlled by a device driver 25. The upper layer of the device driver 25 is a graphic, windowing and events subsystem (referred to as a GWE subsystem hereinafter). When a user draws a motion track on the touch panel 32 by a stylus, the touch panel sequentially transmits in real time the x and y coordinate data 40 for all touched points on the motion track to the device driver 25. In the device driver 25, the x and y coordinate data 40 are processed by MDD and PDD layers, and then the processed x and y coordinate data 41 are transmitted to the GWE subsystem 12. It should be noted that the x and y coordinate data for the touched points relate to the resolution of the touched points on the touch panel 32; all x and y coordinate data will be processed by the device driver 25 and then be transmitted to the GWE subsystem 12.

Currently, a palmtop device, such as the personal digital assistant (PDA), mostly provides a touch panel as an input device. Further, currently many PDAs utilize the Windows CE operation system of Microsoft; as mentioned above, the device driver structure in this kind of the operation system is shown in FIG. 1. However, in practical applications, it does not perform very well to use a touch panel in a PDA or other palmtop devices. It is mainly because a user will feel that the system slows down and waiting time becomes longer. There are two main reasons for this situation. First, as shown in FIG. 1, for the structure flexibility, the device driver for the touch panel uses a dual-layer structure of the MDD and PDD layers. Such a structure results in an extra burden of function calls between two layers while programs executing so that the system loading increases and the system response slows down. Second, when the user performs a drag and drop action on the touch panel, lots of x and y coordinate data, including all x and y coordinate data of the drag and drop route are transmitted to the device driver, therefore considerable processor resource is consumed, and the system speed slows down.

### SUMMARY OF THE INVENTION

Accordingly, the object of the invention provides a touch panel device driver and an associated method, to speed up the system response to a touch panel, thereby improving the performance of the whole system.

According to the aforementioned object, the present invention provides a touch panel device driver to process inputs from a touch panel. In the following description, a method of data entry is described in which a pointing device such as a pen, stylus or a user's finger is used in conjunction with the touch panel to facilitate data entry. The touch panel device driver is a single-layer structure, which receives the x and y coordinate data for touched points from the touch panel, then directly processes the x and y coordinate data, and then outputs the x and y coordinate data to a graphic subsystem such as a GWE subsystem. The present invention eliminates the burden of function calls in the device driver. Further, the touch panel device driver is set to operate in either a normal mode or a compact mode according to a mode parameter. If the touch panel device driver is set to operate in the normal mode, x and y coordinate data for all touched points on the touch panel are outputted to the graphic subsystem after being processed. When the pointing device contacts the touch panel, this action causes a pair of x and y coordinates for the pen-down point. When the pointing device is lifted from the touch panel, the pen-up action causes a second pair of x and y coordinates for the pen-up point. If the touch panel device driver is set to operate in the compact mode, only pen-up and pen-down points on the touch panel are processed and then outputted to the graphic subsystem. The terms “pen-up” and “pen-down” are used for convenience, but will be appreciated that the pointing device does not necessarily (but may) have pen functionality.

Further, the present invention provides another touch panel device driver for processing inputs from a touch panel. The touch panel device driver is set to operate in either a normal mode or a compact mode according to a mode parameter. In the normal mode, the device driver processes x and y coordinate data for all touched points from the motion track on the touch panel; in the compact mode, only pen-up and pen-down points from the motion track on the touch panel are processed. In other words, the touched points on the motion track between the pen-up and pen-down points are ignored, so as to speed up system response.

Further, the present invention provides a method of driving a touch panel. First, set a mode parameter to control whether an operating mode is either a normal mode or a compact mode. Then, x and y coordinate data from the touch panel is received by the driver, the x and y coordinate data corresponding to touched points touched by a user on the touch panel. Then, a current operating mode is determined according to the mode parameter. If the normal mode is set, process the x and y coordinate data. If the compact mode is set and the touched point corresponding to the x and y coordinate data is either a pen-up point or a pen-down point, then process the x and y coordinate data. If the compact mode is set and the touched point corresponding to the coordinate value is neither a pen-up nor a pen-down point, ignore the x and y coordinate data. Finally, output the processed x and y coordinate data to a graphic subsystem. Thereby, in the compact mode, the data load that has to be processed and transmitted is reduced and the system response time is improved.

### BRIEF DESCRIPTION OF THE DRAWINGS

The present invention will become apparent from the following detailed description and preferred embodiments with reference to the accompanying drawings in which:

FIG. 1 is a schematic diagram showing a structure of a device driver in a conventional computer system;

FIG. 2 is a schematic diagram showing a driving structure of a touch panel in a conventional computer system;

FIG. 3 is a schematic diagram showing a structure of a touch panel device driver according to an embodiment of the invention; and

FIG. 4 shows a flow chart of a touch panel device driver according to the embodiment of the invention.

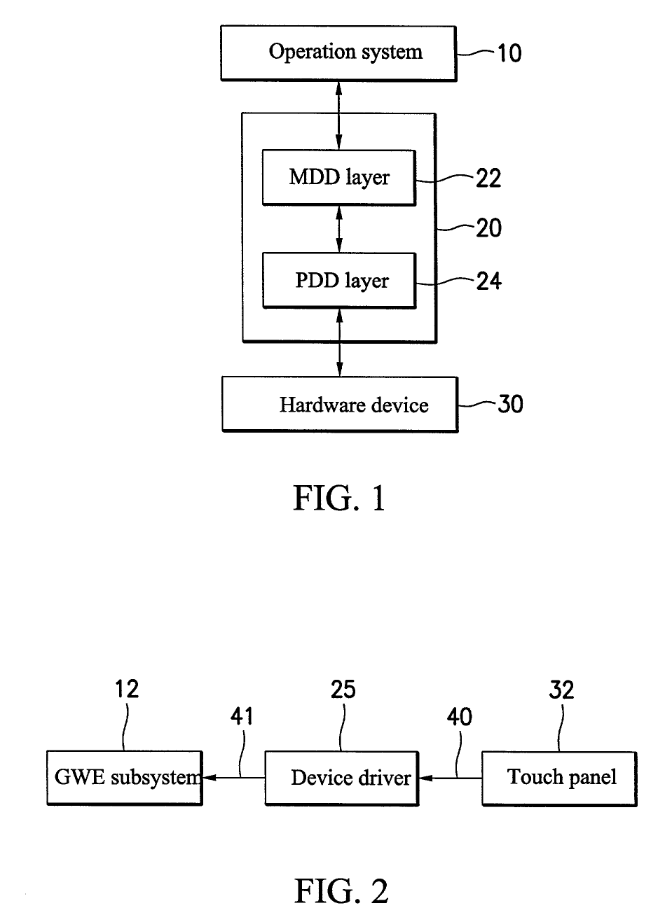

### DETAILED DESCRIPTION OF THE PREFERRED EMBODIMENTS

The touch panel device driver disclosed in the embodiment overcomes the drawbacks in the prior arts to improve the response speed and the system performance.

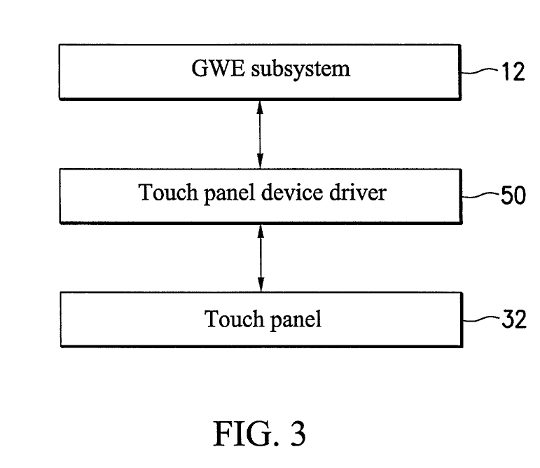

FIG. 3 is a schematic diagram showing the structure of a touch panel device driver 50 in the embodiment. As shown in the figure, being a single-layer structure, the touch panel device driver 50 is not divided into an MDD layer and a PDD layer internally. The touch panel device driver 50, as would a conventional device driver in function, receives the x and y coordinate data for touched points on a touch panel 32, then directly processes the x and y coordinate data, and then outputs the x and y coordinate data to a GWE subsystem 12. By using a single layer rather than two layers, the touch panel device driver 50 eliminates the burden of internal function calls, thereby solving the problem of system resource waste caused by multiple calls in the prior arts. On the other hand, as mentioned above, most computer systems of this kind belong to PDA or other closed systems. Therefore, the change would not influence the design flexibility much.

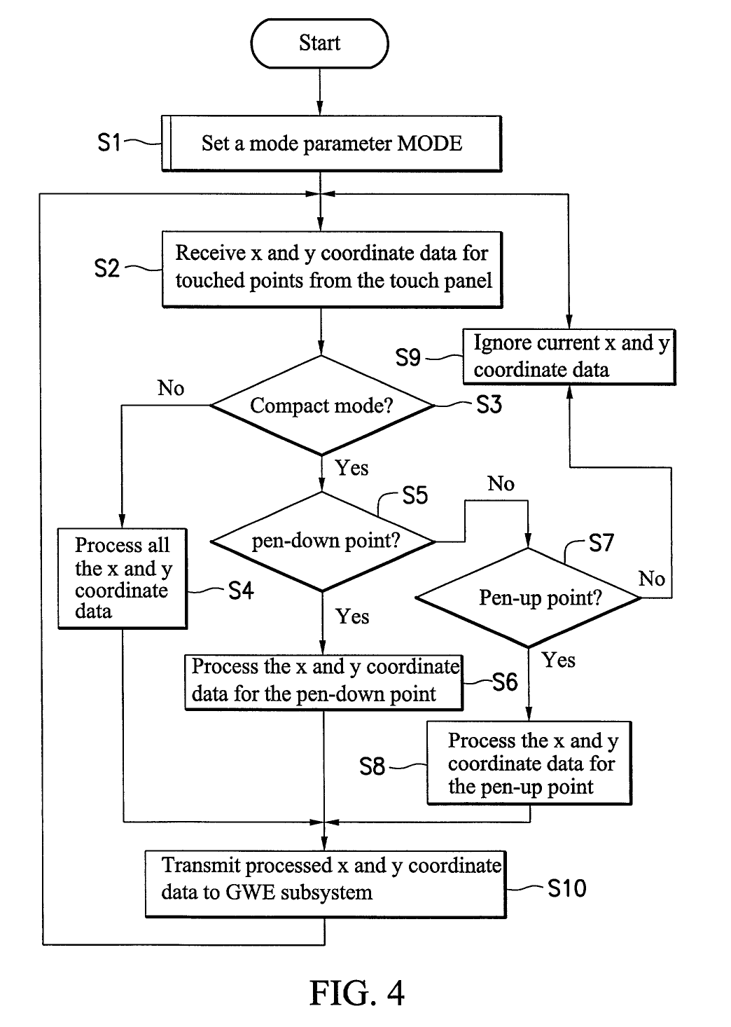

FIG. 4 shows a flow chart of the operation of a touch panel device driver 50 in the embodiment. The main feature is to introduce a compact mode, to selectively simplify the operation of the device driver. In the compact mode, the device driver, instead of processing x and y coordinate data for all touched points, processes only the x and y coordinate data for the pen-up and pen-down points touched by a user on the touch panel. Both kinds of touched points, pen-down and pen-up points, correspond to the start point and the end point of a continuous motion track drawn by a stylus on the touch panel. In other words, the device driver processes only the start point and end point of a continuous motion track, but ignores the other touched points. The method reduces lots of x and y coordinate data to be processed.

Referring to FIG. 4 again, the user first sets a mode parameter MODE instep 1 so as to adjust the current touch panel device driver 50 to be in either a normal mode or a compact mode. As mentioned above, the device driver in the compact mode processes only the start point and the end point of a continuous motion track, and therefore it is more suitable for the operations such as control, drag & drop and window resizing operations. On the other hand, if coordinate data is necessary for the entire motion rather than just the start and end points, the user must set the operation mode to be a normal mode.

After the mode is set, the touch panel device driver 50 may start to receive x and y coordinate data for touched points from the touch panel 32, the x and y coordinate data corresponding to the location of the touched points touched on the touch panel 32 (step S2). Then, it is determined whether the current operation mode is in a compact mode according to a mode parameter MODE (step S3). If the mode parameter MODE indicates that operation is in a normal mode, it means that all the x and y coordinate data need to be processed, therefore each corresponding process needs to be performed on the x and y coordinate data (step S4), and then the processed x and y coordinate data are transmitted to a GWE subsystem 12 (step S10). Then proceed back to step S2 to continue processing the next x and y coordinate data.

On the other hand, if in step S3 the current operation mode is determined to be a compact mode, it is necessary to further judge whether the touched point corresponding to the current x and y coordinate data is a pen-down point (step S5). If so, the corresponding x and y coordinate data is also to be processed(step S6), and then the processed x and y coordinate data are transmitted to the GWE subsystem 12 (step S10). Then proceed back to step S2 and continue processing the next x and y coordinate data. The way to process a pen-up point (step S7) is similar to the way to process a pen-down point. If the current touched point is a pen-up point, process the corresponding x and y coordinate data (step S8). Then, the processed x and y coordinate data are transmitted to the GWE subsystem 12 (step S10). Then proceed back to step S2 and continue processing next x and y coordinate data. Finally, if the touched point corresponding to the current x and y coordinate data is neither a pen-down point nor a pen-up point (e.g., the current pen point is any other point on the motion track), ignore the current x and y coordinate data (step S9). Then proceed back to step S2 and continue processing next x and y coordinate data. By the aforementioned method, according to the setting of a normal mode or a compact mode, the workload of the touch panel device driver 50 can be adjusted, so as to speed the response of the touch panel 32 to a user as well as improve the performance of the whole system.

Alternatively, in the compact mode, there are x and y coordinate data generated only for pen-up and pen-down points, but no x and y coordinate data generated for other touched points between a pen-up point and a pen-down point.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments which may fall within the scope of the invention defined by the following claims and their equivalents.

What is claimed is:

1. A touch panel device driver for processing inputs from a touch panel wherein the device driver operates in either a normal mode or a compact mode; wherein
in the normal mode, said driver processes x and y coordinate data for all touched points from the touch panel; and
in the compact mode, said driver processes x and y coordinate data for pen-up and pen-down points from the touch panel.

2. The touch panel device driver as claimed in claim 1, wherein the pen-down point and the pen-up point correspond to a start point and an end point of a continuous motion track on the touch panel, respectively.

3. The touch panel device driver as claimed in claim 1, wherein x and y coordinate data tha t have been processed are outputted to a graphic subsystem.

4. A touch panel device driver for processing inputs from a touch panel, comprising:
a single-layer driver for receiving x and y coordinate data for touched points from the touch panel, directly processing the x and y coordinate data, and outputting the x and y coordinate data to a graphic subsystem, wherein the driver operates in either a normal mode or a compact mode; wherein
if said driver is in the normal mode, the x and y coordinate data for all touched points from the touch panel are processed and outputted to the graphic subsystem; and if said driver is in the compact mode, only the x and y coordinate data for pen-up and pen-down points from the touch panel are processed and outputted to the graphic subsystem.

5. A method of driving a touch panel, comprising the steps of:
setting a mode parameter which controls whether an operating mode is either a normal mode or a compact mode;
receiving x and y coordinate data from the touch panel, in which the x and y coordinate data correspond to a touched point from the touch panel;
if the operating mode is in the normal mode, processing said x and y coordinate data; and
if the operating mode is in the compact mode and the current touched point corresponding to the x and y coordinate data is either a pen-up point or a pen-down point, processing the x and y coordinate data, otherwise ignoring the x and y coordinate data.

6. The method as claimed in claim 5, further comprising a step of:
outputting x and y coordinate data that have been processed to a graphic subsystem.

7. A method of driving a touch panel, comprising the steps of:
setting a mode parameter which controls whether an operating mode is either a normal mode or a compact mode;
if the operating mode is in the normal mode, receiving and processing x and y coordinate data for all touched points from the touch panel; and
if the operating mode is in the compact mode, receiving and processing x and y coordinate data for pen-up or pen-down points from the touch panel.

8. The method as claimed in claim 7, further comprising a step of:
outputting x and y coordinate data that have been processed to a graphic subsystem.
